(19) United States
(12) Patent Application Publication
(10) Pub. No.: US 2022/0040956 A1
(43) Pub. Date: Feb. 10, 2022

(54) PROTECTIVE BARRIER FOR SURFACES

(71) Applicant: Racing Optics, Inc., Las Vegas, NV (US)

(72) Inventors: Bart E. Wilson, Las Vegas, NV (US); Roger Cone, Las Vegas, NV (US)

(21) Appl. No.: 17/388,891

(22) Filed: Jul. 29, 2021

Related U.S. Application Data
(60) Provisional application No. 63/060,950, filed on Aug. 4, 2020.

(51) Int. Cl. B32B 7/06; B32B 27/08; B32B 7/12; B32B 3/26

(52) U.S. Cl. CPC B32B 7/06; B32B 27/08; B32B 7/12; B32B 2307/41; B32B 2451/00; B32B 2307/732; B32B 3/26

(57) ABSTRACT

A roll if formed of a plurality of large but thin, elongated strips of decorative material. The strips may have a length greater than ten feet and a width of at least one foot and including at least a top strip and a bottom strip with the bottom side of each strip having a dry, pressure sensitive adhesive configured to releasably adhere to an adjoining top side of a different strip, except for the bottom strip which is releasably adhered to a release layer. Each elongated strip has a thickness less than 0.02 inches and a refractive index greater than 0.2, with a plurality of initial release areas at periodic locations along the length of the elongated strips.

### CROSS-REFERENCE TO RELATED APPLICATIONS

This application relates to and claims the benefit of U.S. Provisional Application No. 63/060,950, filed Aug. 4, 2020 and entitled “PROTECTIVE BARRIER FOR SURFACES,” the entire content of which is expressly incorporated herein by reference.

### STATEMENT RE: FEDERALLY SPONSORED RESEARCH/DEVELOPMENT

Not Applicable

### BACKGROUND

Graffiti seems to appear on all forms of publicly accessible surfaces, covering millions of square feet of surfaces on signs, benches, elevators, buildings, walls, and other publicly accessible surfaces. The costs of removing and repairing graffiti is estimated in the millions of dollars each year for large cities, and significantly more money for the entire nation. There is thus a need for a more cost effective way to repair or remove graffiti.

While graffiti makes many surfaces unsightly, wear from repeated use, occupational damage, from environmental causes or vandalism may also mark exposed surfaces and make them sufficiently unsightly or damaged to warrant repair or replacement. The time and cost of replacing or repairing a marble entry way, floor or column may be prohibitive. Likewise, the time and cost of repainting a bathroom wall may be viewed as excessively expensive and time consuming. There is thus a need for a fast and cost effective way to repair or replace such worn or damages surfaces.

Removing graffiti and replacing worn surfaces takes time, which may disrupt or entirely prevent the use of not just the surface in question, but hinder use or access to structures to which the surfaces are affixed. There is thus a need for a way to repair or replace worn or damaged surfaces in a fast and efficient manner, which reduces or minimizes disruption of use of the surface in question.

Removable protective films are known for application to various face shields for helmets, goggles or glasses, as disclosed in U.S. Pat. Nos. 9,295,297, 9,905,297, 9,918,154 and 10,226,095. But these patents require optical quality, highly transparent protective films which increases costs and makes them impractical for many large area surfaces. There is thus a need for a protective layer that is less expensive and of wider applicability for its use.

U.S. Pat. Nos. 6,777,055 and 6,461,709 describe a stack of removable films for windows and signs, with staggered holes to allow removal of the successive film sheets. But these stacks of removable films are transparent which increases costs and limits usage. There is thus a need for a better way to protect surfaces.

U.S. Pat. No. 4,842,919 describes a protective strip of material and a strip of pressure sensitive adhesive both wrapped in a helical path around a rotating tube, with an outer edge of the strip cut to form discontinuities located at ever increasing distances apart to accommodate the increasing diameter of the roll so that the discontinuities are located along lines extending radially outward. Pads containing aligned discontinuities are then cut directly from the roll with the aligned discontinuities allowing removal of successive layers from the pad. Cutting the pads directly from the roll of material presents difficulties and limits the size of the pads. There is thus a need for an improved way to manufacture stacks of layers of material, especially for large stacks.

### BRIEF SUMMARY

A roll or stack of decorative laminates is provided having a plurality of elongated strips of decorative material with opposing top and bottom sides. The elongated strips may have a length greater than ten feet and a width of at least one foot and include at least a top strip and a bottom strip. The bottom side of each of the plurality of elongated strips has a dry, pressure sensitive adhesive configured to releasably adhere to an adjoining top side of a different one of the plurality of elongated strips, except for the bottom side of the bottom strip which is releasably adhered to a release layer. Each of the elongated strips may have a thickness less than 0.02 inches and a refractive index greater than 0.2. The elongated strips have a plurality of initial release areas at periodic locations along the length of the elongated strip. The elongated strips of decorative material are preferably but optionally wound around a longitudinal axis to form the roll.

The roll may include one or more of the variations mentioned in this summary of the invention. The variations may include a roll of decorative laminates having an elongated central support extending along the longitudinal axis with the plurality of elongated strips of decorative material wound around the central support to form the roll. It is believed to be advantageous to have from 3 to 10 elongated strips in the roll, but the number may vary.

Each of the initial release areas may have a center measured along the length of the strip and the distance between each of those adjacent centers is preferably the same, but a further plurality of the plurality of initial release areas may have a periodic variation in size. A plurality of the plurality of initial release areas may have a periodic variation in size. Moreover, the plurality of initial release areas are preferably located along at least one edge of one or more of the elongated strips. Some or all of the initial release areas may also be located within a periphery of the elongated strips.

The roll may also include a plurality of holes extending through the plurality of elongated strips with the holes aligned parallel to an axis perpendicular to the top surface of the top sheet when the sheet is flat, the holes having a circular or quadrilateral shape. Each of the strips of decorative material may be made of PET and the dry, pressure sensitive adhesive may be made of PMMA. The elongated strips are preferably opaque, but may be translucent, and less preferably optically transparent with a refractive index of 0.2 or less.

Each of the elongated strips advantageously has printed indicia that is the same on each elongated strip, in size, location and color. Each elongated strip may include an image or printed indicia that repeats itself a plurality of times along the length of the elongated strip. Advantageously, the image or printed indicia is selected from the group consisting of: stone, wood, water or metal.

There is also provided a method of manufacturing a stack of decorative sheets. The method may include unrolling at least a portion of the roll of laminates and variations thereof described above and cutting through the elongated strips and release layer at a location passing through at least one initial release area to form the stack with each elongated strip forming a sheet of the stack.

The method may include any of the following variations, including cutting through at least one initial release area that is located entirely within the periphery of the elongated strip. The method may include locating the cutting step so the cut does not pass through at least one initial release area in the stack, or performing the cutting step so the cut does not pass through at least two holes located entirely within the periphery of the stack. The cutting step may include cutting along the length of the elongated strip and also cutting transverse to the length of the roll.

In further variations on the method, the initial release area may include a stairstep configuration and wherein each elongated strip comprises a step in that stairstep configuration. The elongated strips may also contain printed indicia that is repeated a plurality of times, and the cutting step is selected to form so it has that printed indicia on each sheet in the stack.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an exploded perspective view of a large table having a stack of decorative sheets on the top of the table;

FIG. 2 is a partial sectional view taken along section 2-2 of FIG. 1;

FIG. 3A is a perspective view of a stack of decorative sheets with staggered bottom ends and a top sheet being peeled off of the stack;

FIG. 3B is a perspective view of a stack of decorative sheets with a staggered edge along one side of the stack;

FIG. 3C is a perspective view of a stack of decorative sheets with a bottom corner having staggered edges on each sheet forming that corner;

FIG. 3D is a perspective view of a stack of circular sheets with staggered edges around the entire periphery;

FIG. 3E is a perspective view of a stack of triangular sheets with staggered edges around two of three sides of the periphery;

FIG. 3F is a perspective view of a stack of decorative sheets with a curved stair step at one corner of the stack;

FIG. 3G is a section view of a stack of decorative sheets with an inverted stair step configuration for the initial release area;

FIG. 3H is a section view of a stack of decorative sheets with each adhesive layer ending inward of an outer edge of the decorative sheets so the outer edges are not adhered to an adjacent sheet;

FIG. 4 is a sectional view of a structure with a stack of decorative sheets suspended therefrom by a post or pin and resting against a ledge or other support;

schematic perspective view of an illustrative production sequence for a stack of decorative sheets;

FIG. 5 is a schematic perspective view of an illustrative production sequence for a stack of decorative sheets;

FIG. 6 is a schematic perspective view of an illustrative production sequence for a stack of decorative sheets;

FIG. 7 is a perspective view of a roll of laminated sheets wound around a central support;

FIG. 8 is a perspective view of a roll of laminated sheets wound in a cylinder and held in that shape;

FIG. 9A is a schematic perspective view of an illustrative production sequence for a roll of elongated strips; and

FIG. 9B is a sectional view taken along section 9B-9B of FIG. 9A.

### DETAILED DESCRIPTION

As used herein, the numbers refer to the following parts or steps throughout: 10—stack; 10′—elongated strip; 12—decorative sheet; 12′—decorative strip; 14a—front surface; 14b—back surface; 16—dry, pressure sensitive adhesive; 18—release layer; 20—release initiation area; 22—surface of structure; 24—structure; 26—post; 28—ledge; 30—holes; 32—printed indicia; 40—roll of decorative material; 42—strip of decorative material; 44—roll of adhesive and release strips; 46—adhesive strip; 48—release strip; 50a,b—laminating rollers; 52—laminated strip; 54—adhesive applicator; 56—cutting station; 58—sizing station; 59—cutting device; 60—stacking station; 68—larger stack of stacks; 70—central support; 72—roll; 74—longitudinal axis; and 76—restraining band.

The Stack of Sheets

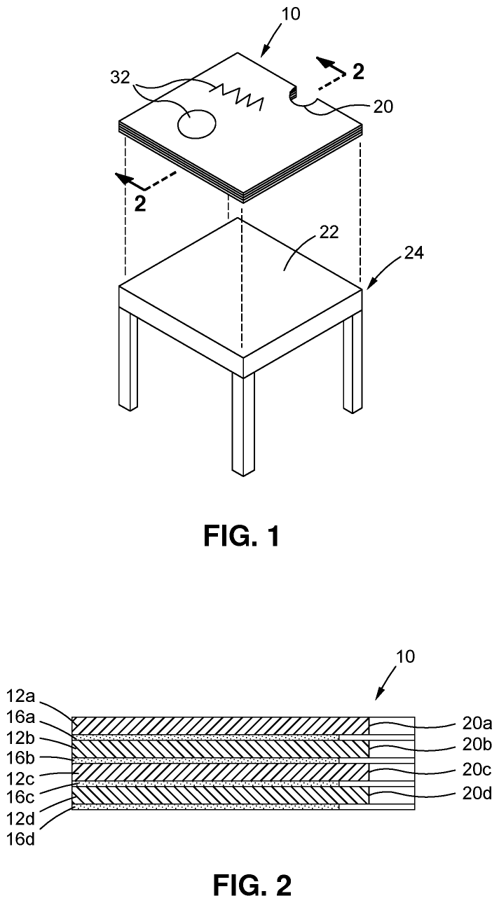

Referring to FIGS. 1-4, a method and apparatus for forming a stack 10 of a plurality of removable, decorative sheets 12, illustrated as four sheets 12a to 12d but recognizing that the number of sheets may vary from one or two, to more than 20, but are usually 10 sheets or less. Stacks having 3-10 sheets are believed preferable as more are believed to make the stack unduly thick and heavy and fewer are believed to make the stack less usable as many situations require more than two peel-off layers. Each decorative sheet 12 has a front or exterior surface 14a and an opposing back or bottom surface 14b, with a layer of dry, pressure sensitive adhesive 16a to 16d covering at least a portion the back or bottom surface 14b. The dry, pressure sensitive adhesive 16 and the material of the sheets 16 are selected so that each successive sheet 12a to 12d may be peeled from the front surface 14a of the adjoining sheet, but will otherwise stick to the adjoining surface to which the adhesive layer (and decorative sheet 12) are applied, with the bottom sheet 12d sticking to surface 22 of structure 24 to which the stack is fastened by bottom adhesive layer 16d. The bottom adhesive layer 16d may be the same as prior adhesive layers 16a, 16b and 16c, but it is preferably different in type, adhesion, thickness, layout or amount because it is configured to hold the entire stack 10 to the surface 22 of structure 24 during use, and is not removed from the surface 22 when sheets 12a, 12b, and 12c are peeled off and removed from the stack.

The term “bottom adhesive layer” will be used to refer to this last adhesive layer, which for example, is layer 12d in FIG. 2, and releasably adheres to the structure 24 when the release layer is removed. Thus, if there are only three sheets 12a, 12b and 12c and three adhesive layers 16a, 16b and 16c and layer 16c adheres the stack to the surface 22 of structure 24, then the bottom adhesive layer is adhesive layer 16c. In a similar manner, the “bottom sheet” will be used to refer to the last sheet in the stack 10, the sheet that is adhered to the surface 22 of structure 24. Thus, bottom sheet in FIG. 2 is sheet 12d, and in the example with three only sheets 12 in the stack, the bottom sheet is sheet 12c.

The top sheet or topmost sheet refers to the outermost sheet 12 of the stack 10, the sheet 12 on the opposite end of the stack 10 as the bottom sheet (e.g., sheet 12d in FIG. 2). Thus, as used herein, the relative positions and relative directions top and bottom, upper and lower, above and below, are with respect to the relative positions along an axis extending from the bottom sheet (e.g., sheet 12d in FIG. 2) to the top sheet (sheet 12a in FIG. 2), so that top sheet 12a is above sheet 12b, while adhesive layer 16d and release layer 18 are below the bottom sheet (e.g., sheet 12d in FIG. 2).

Each stack 10 advantageously has 4 to 8 decorative sheets 12, but may have fewer, or more decorative sheets. Thus, for example, a stack of 4 decorative sheets 12 also has four layers of dry, pressure sensitive adhesive 16a to 16d, each associated with a different decorative sheet 12a to 12d. For shipment and handline, a release layer 18 is placed on the bottom adhesive layer (e.g., layer 16d in FIG. 2) so the stack 10 can be handled without risk of sticking to objects (or fingers) that come into contact with an exposed layer of pressure sensitive adhesive 16d on the bottom of the stack 10. The release layer not only avoids sticking the stack 10 to unintended objects, but it avoids debris and contaminants from sticking to the bottom adhesive layer 16d. At the time of attaching the stack 10 to the support surface 22 of structure 24, the release layer 18 can be removed from the bottom adhesive layer to expose the bottom adhesive layer so it can adhere to the desired surface 22 of the desired structure 24. In use, pressure can be applied to the stack 10 causing the bottom adhesive layer to adhere to the surface 22 of the structure 24 to adhere stack 10 to the surface and structure.

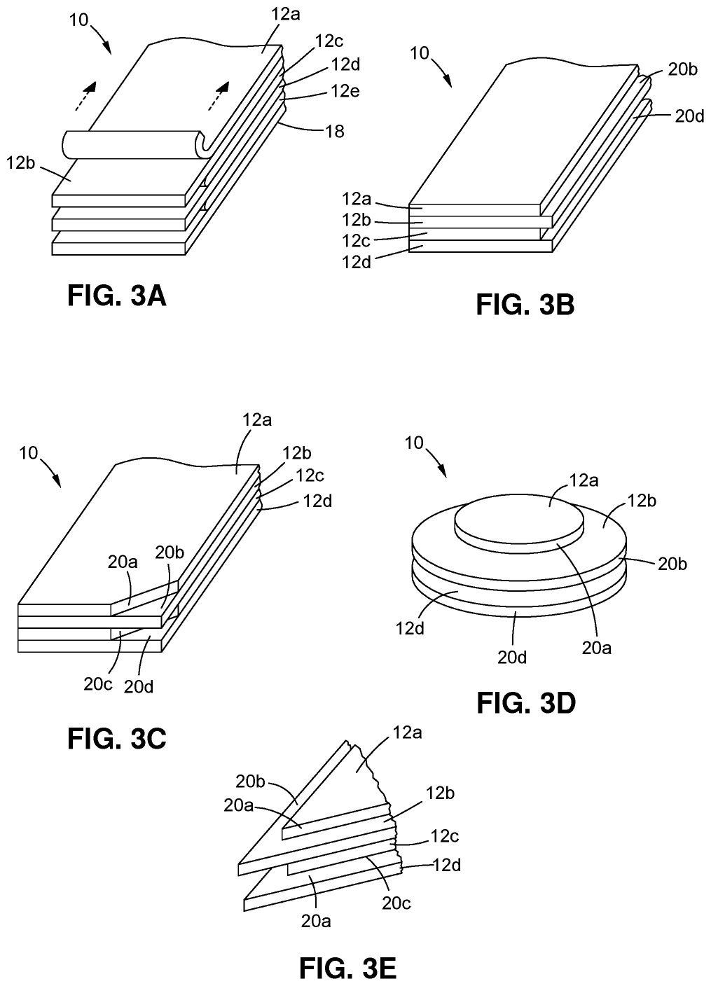

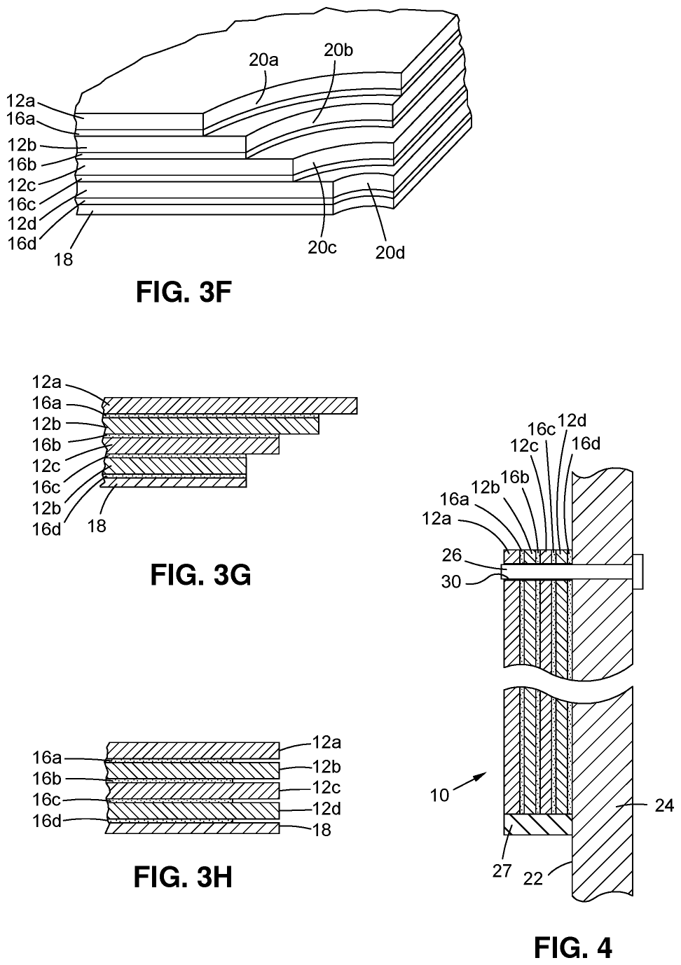

Referring to FIGS. 3A to 3H, one or more initial release areas 20 are formed in each stack 10, preferably located at a corner, or along a peripheral edge of the decorative sheet. The initial release area 20 in each decorative sheet 12 of a stack 10, preferably differ from each other and advantageously cooperate to form a stepped or staggered configuration forming a plurality of extending or recessed edges of the respective decorative sheets 12 in the stack 10. The initial release areas 20 are sized and configured so a person can use a fingernail or a tool such as a screwdriver to engage the initial release area and peel the edge of a top, decorative sheet 12 away from the lower sheet adhered to that top sheet a distance great enough to engage the top decorative sheet and peel it off the stack 10. For example, a user can engage the peripheral edge of sheet 12a at the initial release area 20a and pry it away from the adjacent decorative sheet 12b a short distance sufficient to grab more of the sheet 12a and peel it off the stack and away from the next sheet in the stack, sheet 12b. The staggered sides or edges of adjoining or alternating sheets 12 may extend along the entire length of the side or edge of the decorative sheet 12, or may extend for only a short distance sufficient to initiate peeling away of the topmost sheet 12. The location of the initial release areas is optionally but preferably selected and located on the stack so that when the stack is positioned on the structure 24, to be difficult for vandals to locate and use.

Referring to FIG. 3H, the initial release areas 20 may also be formed by not having the adhesive layer 16 extend all the way to the edge of the decorative material 12, which allows the unadhered edge of the sheet to be more flexible and to more easily peel away from the lower adjoining sheet 12 in the stack, thus facilitating removal of the top decorative sheet 12. With a non-adhered edge of the sheet 12, the omitted adhesive layer 16 may also provide a physically detectable gap to allow a tool such as a knife blade, screwdriver blade or fingernail to detect the gap between adjoining sheets 12 and begin to peel the adjoining sheets apart.

The dry, pressure sensitive adhesive 16 is a dry, pressure sensitive adhesive layer that may form a continuous and uninterrupted adhesive surface over at least the center portion of the decorative sheet 12. As used herein, an adhesive layer covering a majority of the sheet 12 refers to covering over half the area of the sheet on which the adhesive is placed. An adhesive layer covering a substantial portion of the sheet 12 refers to covering over 90% of the area of the sheet on which the adhesive is placed.

The dry, pressure sensitive adhesive 16 is preferably self-wetting and attaches the stack 10 to the desired surface 22 on a structure 24 to which the stack is applied so that any air between the stack and the surface 22 can be removed after the stack is attached and/or adhered to the surface 22 and structure 24, for example, by applying pressure across the surface of the stack (e.g., by a squeegee or by hand), to move the air toward an edge of the stack where the air may be expelled from the interface between the stack and the surface 22 of the structure 24. This allows air pockets to be removed or reduced in size. A dry mount, pressure sensitive adhesive layer comprised of an acrylic polymethyl methacrylate (PMMA) material or a high index silicone adhesive are believed suitable for adhesive 16. Depending on the use of the stack 10, the dry, pressure sensitive adhesive can also be selected to have high temperature, humidity, and UV resistance. In some embodiments, the dry, pressure sensitive adhesive may be selected to have non-yellowing properties.

The dry, pressure sensitive adhesive layers 16a, 16b, etc., are preferably the same adhesive. But it is advantageous to use a stronger, yet releasable, adhesive for the bottom adhesive layer 16 adhering to the surface 22 of structure 24, which is layer 16d in the FIG. 2d.

The adhesive layers 16 may be provided in various form factors for pre-application onto the bottom 14b of sheets 12 so as to removably adhere the sheets together and to adhere the bottom sheet to the surface 22 of support 24. Regardless of the method of application to the bottom 14b of the sheets 12, the bottom adhesive layer (e.g., layer 16d in FIG. 2) is selected to releasably adhere to the releaser layer 18 so the release layer may be peeled off, and is selected to releasably adhere to the surface 22 of the structure 24 sufficiently so that the upper layers of the stack 10 may be peeled off without also peeling the bottom layer 18 and bottom sheet 12 off of the surface 22 of structure 24. Similarly, the other adhesive layers 16 are selected to hold the sheets 12 to the stack 10 while allowing upper sheets 12 to be peeled off.

The bottom adhesive layer 16a may be applied to the bottom surface 14b of the bottom sheet 12d by pouring a liquid adhesive over that bottom surface and letting the liquid spread over the bottom surface 14b of the lowest sheet 12d. Alternatively, the bottom adhesive 16d may be sprayed over the bottom surface 14b of the lowest sheet 12d. As a further alternative, the bottom adhesive 16d may be provided as a film and be laminated on the bottom surface 14b of the bottom sheet 12d.

If optical transparency is desired, the refractive index of the dry, pressure sensitive adhesive 16 and any intervening removable sheet(s) 12 in the stack 10 are matched to within 0.2, or even within 0.1.

The decorative sheets my comprise a polycarbonate material, a polyethylene terephthalate (PET or PETE) material, or other polymers (including plastics) suitable to the specific application for the structure 24 and its surface 22. Each decorative sheet 12 need not be of the same material and stacks with a polycarbonate top sheet 12 and intermediate sheets of PET are believed suitable. The adhesive layers 16 between sheets 12 can each be or comprise an acrylic polymethyl methacrylate (PMMA) material or a high index silicone, or other dry mount, pressure sensitive adhesives suitable for the use of the structure 24 to which the stack is applied during use.

The peel strength of the pressure sensitive adhesive 16d on the bottom sheet 12d is preferably adjusted to correlate with the peel strength of the pressure sensitive adhesive 16 holding the sheets 12 of the stack 10 together (e.g., adhesive layers 16a, 16b and 16c). For example, in some embodiments, the peel strength of the bottom adhesive layer 16d may be relatively high when compared to the peel strength of the pressure sensitive adhesive 16 holding the separate sheets 12 (12a, 12b, 12c) of the stack 10 together to ensure that the stack remains attached to the surface 22 of structure 24 when the various layers of sheets 12 of the stack 10 are removed or peeled away. Thus, while a dry, pressure sensitive adhesive 16 is disclosed as located between each of the sheets 12 and between the bottom sheet 12 and the surface 22 of the structure 24 to which the stack 10 is attached, the thickness, coverage area, coverage pattern, amount, and type of adhesive 16 may vary in each adhesive layer. It may especially vary in between the bottom adhesive layer (e.g., layer 16d in FIG. 2) adhering to surface 22 which must be stronger than that of the adhesive layers 16a, 16b, 16c etc. releasably adhering to the bottoms 14b of sheets 12a, 12b and 12c. It is believed desirable that the peel strength of the bottom adhesive layer (e.g., layer 16d in FIG. 2) be about twice the peel strength necessary to remove the decorative sheets 12a, 12b and 12c (etc.) located above the bottom sheet (e.g., sheet 12d in FIG. 2).

The correlation between the peel strength of the dry mount adhesive layer and the peel strength of the adhesive holding the layers 14 of the stack 10 together can depend upon how the stack 10 is mounted to the lens 16. For example, where the stack 10 is intended to be dry mounted to a lens 16 without the use of pins or posts applying tension to the stack, it can be useful to use a dry mount adhesive that offers a peel strength that is about twice the peel strength necessary to remove the removable layers 14 of the stack 10.

Using an adhesive 16 that offers a peel strength that is too high can present drawbacks. For example, where a stack 10 has the sheets 12a, 12b, 12c and 12d fastened with dry, pressure sensitive adhesive 16 having a peel strength that is too high, there can be a significant risk of adhesive transfer. That is, where the peel strength is too high, removing any sheet 12 from the remainder of the stack 10, or removing stack 10 from the surface 22 of structure 24, can cause the adhesive layer to fracture, thereby leaving behind a residual portion of the adhesive 16 on the surface 14a of the remaining adjacent sheet 12 or the surface 22 and structure 24. This adhesive residue can cause debris and undesirable materials to stick to the surface 14a or surface 22 and adhesive residue on the surface 22 can make the process of mounting another stack 10 to the surface 22 difficult and inefficient. Thus, the dry, pressure sensitive adhesive material 16 for the sheets 12 and for the bottom adhesive 16d is selected and configured to provide a peel strength high enough to maintain the sheets 12 attached to the stack 10 during use until each of the sheets 12 is peeled away, and to maintain the stack 10 attached to the surface 22 of structure 24 when each of the sheets 12 are peeled away, but with the adhesion being low enough to allow the stack 10 and sheets 12 to be peeled away without leaving behind residual adhesive 16.

The correlation between the peel strength of the dry, pressure sensitive adhesive layer 16 and the peel strength of the adhesive holding the layers 14 of the stack 10 together can depend upon how the stack 10 is mounted to the surface 22 of structure 24. For example, where the stack 10 is intended to be dry mounted to a surface 22 that is vertical, without the use of pins or posts 26 to assist in holding the stack in position, it can be useful to use a dry, pressure sensitive adhesive that offers a peel strength that is greater than the peel strength needed to remove the decorative sheets 12 of the stack 10. In some embodiments, the peel strength for each of the removable sheets 12 can be between about 10 grams and about 50 grams when measured using a 180° peel test at a 12 inch per minute rate, with an average peel strength of about 25 grams to about 30 grams for each removable sheet 12. Thus, in such an embodiment, the dry, pressure sensitive adhesive can be selected to have a peel strength of about 50 grams to about 60 grams, i.e., about twice that of the average peel strength of the removable sheets 12. The peel force will vary with the thickness of the sheet 12 and adhesive 16 as that affects the weight to be peeled, and also depends on the peel strength of the adhesive 16, and the size of the sheet 12—particularly the linear length of the peeled portion as that affects the length of the adhesive line that must be peeled.

Referring to FIG. 4, as another example, where the stack 10 is intended to be fastened to a vertical or substantially vertical surface 22 (i.e., within 10 degrees of vertical) using pins or posts 26 for support and positioning, the peel strength of the dry, pressure sensitive adhesive 16 may be equal to, or even less than that of the removable sheets 12. Because the pins and/or posts cooperate with edges of the stack 10 or mating holes 30 through some or all of the stack, they can help maintain the position of the stack on the surface 22 when the removable sheets 12 are peeled away.

When the stack 10 is intended to be suspended from an inclined or horizontal surface 22 such as a ceiling or the sides of an inclined and downward facing arch, the bottom adhesive layer 16 (e.g., layer 16d in FIG. 2) is advantageously configured to support the entire weight of the stack 10, and the additional force that arises when each sheet 12 is peeled off of that suspended stack. Similarly, the adhesive layer 16 between the top and bottom sheets 12 is configured to support the weight of the other sheets as they are suspended, in addition to withstanding the force required to peel the other sheets off of the stack. Thus, the composition, thickness and area coverage may vary depending on the intended use and/or resulting orientation of the stack 10.

The decorative sheets 12 and/or the dry, pressure sensitive adhesive 16 are preferably not of optical quality so they have a refractive index greater than 0.2, and are advantageously opaque or translucent. As used herein, translucent means that light can pass through a single sheet 12 but that detailed shapes cannot pass through, so that a word typed in 12 point, Times New Roman font, un-bolded type, may be seen but cannot be read through a translucent sheet 12 with the typed word pressed against the sheet. The term opaque means you cannot see through a sheet 12, so that the same word cannot be seen through the sheet with the typed word pressed against the sheet.

The decorative sheets 12 advantageously are non-transparent, and preferably bear printed indicia 32 which may take any form, including text, drawings, images, graphic designs, and other visually perceptible designs. The printed indicia 32 is preferably on the top surface 14a of each sheet 12, but may be on the bottom surface 14b which requires some visibility through the thickness of the sheet 12 bearing the printed indicia. Suitable images for printed indicia 32 are believed to include stone, concrete, wood, water, metal and colored surfaces. For example, a stone appearance or image may resemble marble, granite, slate, rocks, gravel, pebbles or sand, whether of a single piece, multiple separate pieces, or separate pieces joined together as a slate roof or a river-rock wall, or a sandy beach or a rocky driveway or a brick wall or floor. The stone appearance or image also includes tiled walls or floors. Concrete includes floated, cut or polished concrete surfaces. Wood includes natural or finished woods, petrified wood, bark or other wood surfaces whether of a single piece, multiple separate pieces or separate pieces joined together as a wood wall or wood floor or parquet floor. Metal appearances or images may include metallic finishes such as metal foil laminated to plastic supports, including chrome, brass, copper, steel and may further include mirror-like finishes or dull, brushed metal finishes. Colored surfaces include a uniform color across the entire decorative sheet 12, or any combination or arrangement of colors, including recognizable images, paintings or scenes. Luminous colors of the type appearing on motor vehicles are believed suitable for use. Various images of any subject may be used for the printed indicia 32. These examples are given by way of illustration, not limitation.

It is believed suitable, but not preferable, to have the printed indicia 32 on the bottom side 14b of a sheet 12 in the stack 10, with the material of the sheet 12 being transparent or translucent so that the thickness of the sheet protects the printed indicia 32 from damage. To improve visibility of an image through a decorative sheet 12 the material of the decorative sheet may have a refractive index of 0.20 or less, preferably between 0.05 and 0.15. When the printed indicia 32 is on the bottom side 14b of a sheet 12, then the adhesive layer 16 adhering to that bottom side 14b need not be transparent and is preferably opaque or translucent with a refractive index greater than 0.2, because such adhesive layers are believed to block visibility of lower decorative sheets 12 and to enhance the appearance or visibility of the printed indicia in the topmost sheet on the stack.

Each of the decorative sheets 12 in a stack 10 may have the same printed indicia 32, or different printed indicia. The stacks of decorative sheets may be placed adjoining each other or adjacent each other to present scenes of printed indicia 32 such as panoramic views of nature or enlarged images or enlarged messages, with each decorative sheet 12 presenting a portion of the larger image and cooperating to present the panoramic view, the enlarged image or the enlarged message.

The decorative sheets 12 are preferably large in width and/or height but thin in thickness so they may be manually peeled off of the stack 10. As used herein, a “large” sheet has at least one dimension that is 5 feet or more, and preferably between 8 and 10 feet, and has a second dimension at least 10 inches and preferably more. Preferred dimensions are sheets 12 with widths of 1.5, 2, 3, 4 and 5 feet and with heights of 8 to 10 feet, or more. The width and height characterization of the dimensions do not limit the orientation of the sheet during use, so a 1.5 foot wide by 10 foot high sheet 12 may be oriented horizontally, vertically or at any skew angle. The dimensions of the decorative sheet will depend on the use.

For example, decorative sheets 12 for walls of elevators will typically vary from 1 to 10 feet wide, with a height of 8 to 10 feet. Decorative sheets 12 for walls will typically vary from 1-4 foot wide with a height of 8 or 10 feet if the sheets are used with the long length vertical. Decorative sheets to be applied similar to wallpaper may have widths of 21 inches and lengths of 13.5, 27 or 33 feet. Decorative sheets 12 for doors, will typically have a width of 30-48 inches with a height of about 7 or 8 feet. Decorative sheets 12 for refrigerator doors will typically have a width of 2 to 4 feet with a height of 5-7 feet. Decorative sheets for floors may have widths of 1 to 4 feet and lengths measured in tens of feet.

Because of the dry, pressure sensitive adhesive 16 on the bottom surface 12d, the dimensions of the stack 10 and sheets 12 may be limited more by the stack's weight and the maneuverability needed to accurately position the stack 10 relative to the structure 24 and any support such as posts 26 and ledges 28. The bottom adhesive layer (e.g., layer 16d in FIG. 2) is releasable and may be repositioned, but only by peeling the bottom sheet (e.g., sheet 12d in FIG. 2) of the stack 10 off the surface 22 of structure 24 and repositioning it to close any gaps from positioning errors, rather than sliding the stack sideways or lengthwise to close small gaps arising from positioning errors.

The thickness of each of the decorative sheets 12 is typically less than 0.1 inches, and preferably less than 0.02 inches, more preferably less than 0.015 inches and still more preferably under 0.001 inches. Thicker sheets are believed suitable as long as they are sufficiently flexible that they can be peeled off the stack by pulling at one corner or one side of the stack. Each sheet is preferably the same thickness, but need not be so, especially as the bottom sheet 12d may be thicker than the other sheets. Thus, for example, each of the sheets 12 in the stack 10 may have a thickness of between about 0.0005 inches (i.e., half a mil) to about 0.014 inches (i.e., 14 mils).

In some embodiments, depending on the intended use, the number of layers used, and numerous other considerations, the layers may have a greater or smaller thickness. Further, in some embodiments, the thickness of each of the removable sheets 12 of the stack 10 can all be the same; however, some embodiments may include sheets that vary in thickness from sheet to sheet within the stack. For example, some decorative sheets 12 of the stack 10 may be about 0.008 inches (8 mils) thick, while other decorative sheets in the stack 10 may be about 0.002 (2 mils) inches thick.

The thickness of the dry, pressure sensitive adhesive layer(s) 16 can vary depending on the use and the extent of vertical orientation of the stack 10. For example, in some embodiments, the dry, pressure sensitive adhesive layer 16 can be between about 10 microns and 20 microns, or more specifically between 13 microns and 17 microns, or even more specifically, 15 microns thick (i.e., 15 μm or about 0.00059 inches or 0.59 mils. The thickness of the dry, pressure sensitive adhesive layer 16 is often sufficiently thin that it is not visually perceptible, especially if the adhesive layer 16 is the same color as the decorative sheet 12, or transparent. It is believed desirable from an aesthetic viewpoint to have the adhesive layer 16 colored to be transparent, or if the decorative sheet 12 to which the adhesive layer is adhered has a uniform color then to have the adhesive layer match that uniform color. But the make it easier to identify the sheets 12 for peeling the sheets off at the initiation release areas 24, it is believed desirable to have the adhesive layers 16 colored with a contrasting color relative to the edge of the sheets in which the release areas 24 are formed.

While the dry, pressure sensitive adhesive layer 16 may be thin, it typically provides enough separation that if the adhesive layer does not extend all the way to the edge of the adjacent decorative sheet 12 as shown in FIG. 3H, then a tool such as a knife blade, (flat) screwdriver blade or fingernail may detect the gap from the omitted adhesive and pry the topmost layer apart from the lower layer to start to peel off the topmost remaining decorative sheet 12 in the stack. If the dry, adhesive layer 16 does not extend all the way to the edge of the decorative material 12, that also allows the unadhered edge of the sheet to be more flexible and to more easily peel away from the lower adjoining sheet 12 in the stack, thus facilitating removal of the topmost decorative sheet 12.

The initial release areas 20 are configured to allow a user to engage a topmost decorative sheet 12 (e.g., 12a in FIG. 2) an amount sufficient to start peeling that topmost decorative layer 12 from the next lowest decorative sheet (e.g., 12b). As reflected by FIGS. 3A-3G, various configurations of the initial release areas 20 are contemplated, and the configurations may vary with the shape of the stack 10 and decorative sheets 12 and the illustrated configurations are not exhaustive. Extending ledges, sides or corners of the decorative sheet(s) 12 are easy to grasp or engage with a tool, depending on the extent to which the ledge, side or corner extends from the adjacent sheet 12, or the shapes of the corner of the sheets 12 with respect to the surface (e.g., surface 22) to which the sheet is adhered. The initial release areas 20 advantageously have adjoining sheets 12 forming offsets that extend by distances varying from 0.02 to 0.10 inches along a length of 0.2 to 0.5 inches. Larger offsets between adjoining sheets make it easier to engage, which facilitates replacement but also makes it easier for vandals. Even a stack 10 with flush decorative sheets 12 may have the top sheet 12 separated from the stack by inserting a tool such as a knife edge fingernail or screwdriver blade at a corner or convex edge of the stack to pry adjacent sheets apart.

Manufacture

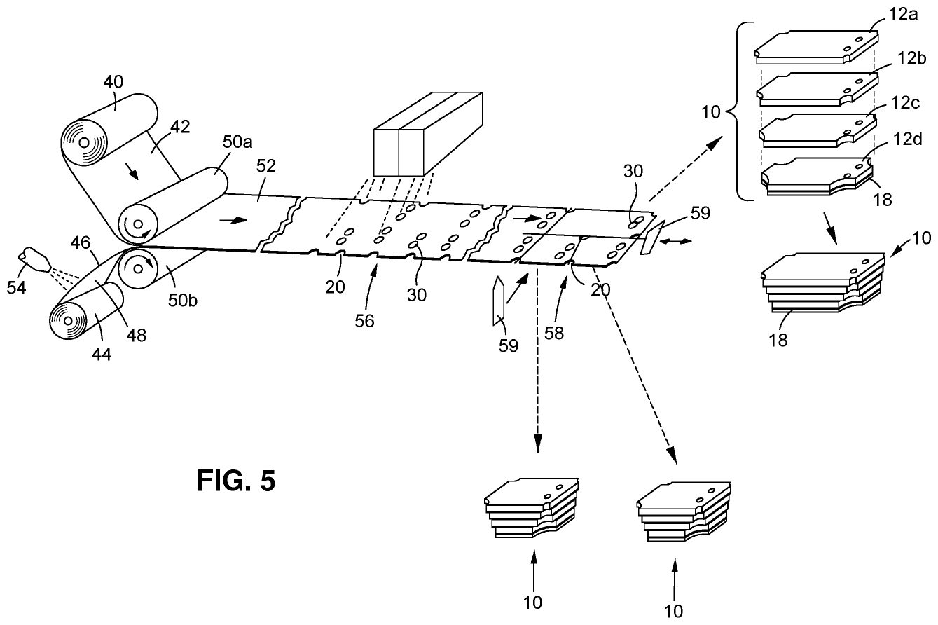

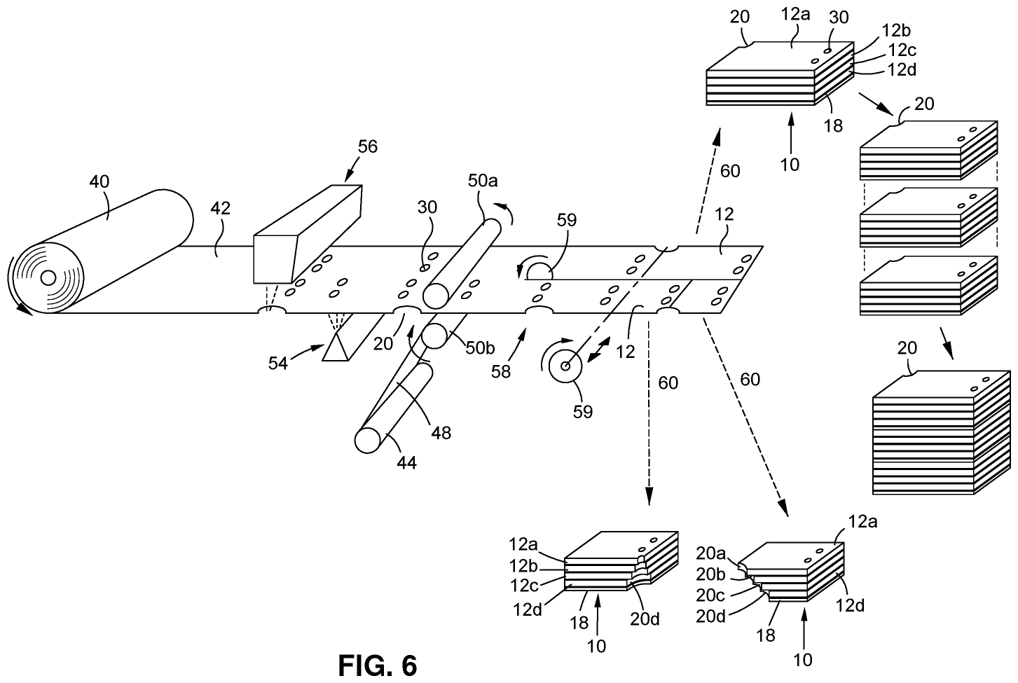

Referring to FIGS. 5-6, several steps may be involved in making the stack 10 of sheets 12 and those steps may occur in various sequences or combinations. A roll 40 has a strip 42 of decorative material wound around a spool to form that roll 40 of decorative material and that decorative material advantageously contains printed indicia 32, or the printed material is added to the strip 42 at a printing station that is preferably located before the stacking station described later, or even added to selected individual sheets 12 before the stacking station. A roll 42 containing an adhesive strip 44 laminated to a release strip 48 passes through a pair of closely spaced, counter rotating laminating rollers 50a, 50b along with the strip 42 to further laminate the adhesive strip 44 onto the strip 42 of decorative material to create a laminated strip 52 having the adhesive strip 46 laminated between the decorative strip 42 and the release strip 48. The laminating rollers 50a, 50b cause the strip of adhesive material 46 to stick to the bottom of the strip of decorative material 42. The result is a continuous laminated strip 52 having a decorative material 42 on an exterior surface with a layer of adhesive material 46 on a bottom side of the decorative material 42, and the strip of release material 48 on the bottom of the layer of adhesive material 46 so the adhesive is between the decorative material and the release strip. The laminated strip 52 may be formed separately and provided as a single roll.

If the strip of decorative material 42 is not already cut to form the initial release areas 20 and/or holes 30 for the support pins or posts, the laminated strip 52 passes to a cutting station 56 where initial release areas 20 and holes 30 may be cut or otherwise formed in the laminated strip 52. The cutting station 56 may use such cutting mechanisms as punches, dies, rotating or reciprocating cutting blades, laser cutters, water jet cutters, and various other mechanisms to remove material and form the initial release areas 20 and holes 30 at the desired locations and of the desired dimensions. The initial release areas 20 and/or holes 30 may be formed at periodic locations in the laminated strip 52. Thus, as shown in FIGS. 5-6, the laminated strip 52 may have a plurality of initial release areas 20 and holes 30 cut at periodic locations along the length and/or width of the laminated strip. Advantageously, the initial release areas 20 are cut at locations that will correspond to a peripheral edge (an preferably a corner) of a decorative sheet 12 cut from the laminated strip 52, but the initial release areas 20 may be entirely within the outer periphery of the decorative sheets 20 and stack 10. The initial release areas 20 and holes 30 need not be symmetrically located because the laminated strip 52 may be cut or slit longitudinally, transversely or at skew angles to the direction of travel to form decorative sheets 12 of various sizes and shapes from different portions of the laminated strip. Because the initial release areas 20 may have a staggered or stair step profile in the assembled stack 10, the adjacent initial release areas 20 on the laminated strip 52 may have slightly different shapes or dimensions.

Preferably after the initial release areas 20 and holes 30 are formed in the laminated strip 52, laminated strip 52 then goes to a sizing station 58 and then to a stacking station 60. In the sizing station 58, the laminated strip 52 with initial release areas 20 and holes 30 is preferably cut or slit into decorative sheets 12 of the desired size and. Cutting devices 59 such as rotating or reciprocating blades, lasers, high pressure fluid jets, and other devices may be used to slit or cut the laminated strip 52 into separate decorative sheets 12. To accommodate the movement of the laminated strip 52 along the direction of travel, transverse cutting devices typically either require temporarily pausing the travel of the strip 52 when the transverse cuts are made, or the transverse cuts may be made at an inclined angle to account for the travel of the laminated strip 52 yet still achieve the desired size and shape of the decorative sheets 12,

In the stacking station 60, the various decorative sheets 12 are sequentially layered on top of each other to form a stack 10 having a desired number of decorative sheets 12 in the stack, and with the initial release areas 20 and holes 30 in each stack 10 being aligned and arranged to form any desired arrangement of the initial release area, such as a stairstep arrangement (FIG. 3F) that is larger at the top decorative sheet 12a and smaller at the bottom decorative sheet 12d, or an inverted stairstep arrangement that is smaller at the top decorative sheet and larger at the bottom decorative sheet (FIG. 3G) or any other arrangement, including those shown in FIGS. 3A-3H. The holes 30 are preferably aligned along a longitudinal axis extending along the center of the hole(s) 30 in each decorative sheet, but need not be so. Pneumatic handling and/or conveyors are believed suitable for use in moving and positioning the decorative sheets 12 to form the stack.

The completed stack 10 of decorative sheets 12 advantageously has a release layer 18 on the bottom surface 14b of the bottom sheet 12d as shown in FIGS. 2-3). The other decorative sheets 12a, 12b, 12c in the stack have their release layers 18a, 18b, 18c removed if such release layers are present before stacking. The release layer may be removed in the sizing station 58 or the stacking station 60. Alternatively, an adhesive layer 16 and release layer 18 may be omitted or not formed along one or more longitudinal strips of the laminated strip 52 so that conveyor rollers may contact the strip of decorative material 42 to move the laminated strip through the manufacturing process. Thus, the roll 44 of adhesive and release strips may have a gap along a length of the material to expose a portion of the decorative material for engagement with equipment to move the laminated strip 52 through the various stations. Likewise, an adhesive layer 16 and release layer 18 may be removed at any of the various process steps to expose the strip of decorative material 42 to facilitate conveyor equipment to contact that strip 42 and convey the laminated strip through the various manufacturing stations.

Referring to FIG. 6, an optional way to provide the adhesive strip 46 is described. An adhesive applicator 54 is located to apply an adhesive strip 46 to either the release strip 48 or to the to the bottom of the decorative strip 42. FIG. 6 depicts a spray applicator 54, but other application devices and methods can be used. The laminating rollers 50a, 50b are shown as located after the cutting station 56 so parts of the adhesive strip 46 do not stick to any equipment of the cutting station forming the initial release areas 20 or holes 30 that preferably extend through the adhesive strip on the bottom of the decorative strip 42. This location after the cutting station 56 is especially advantageous if the adhesive applicator 54 only applies the adhesive strip 46 to the uncut portions of the decorative strip 42 and not to the openings formed by the initial release areas 20 and holes 30. Moreover, if the adhesive applicator 54 applies the adhesive strip 46 to the bottom surface of the decorative strip 42, then only the bottom decorative sheet 12 (e.g., sheet 12d in FIG. 2) has to have the release layer 18 applied thereto which, with the configuration of FIG. 5, may not require the laminating rollers 50a, 50b rotate continuously and contact opposing sides of the decorative material 42, and instead only rotate and contact the decorative material when needed to laminate the release strip 48 to the bottom of the decorative strip 42 (with the adhesive strip therebetween). Various other arrangements of the basic processing steps describe here may be used.

Handling Flat Stacks

Because the decorative sheets 12 with an adhesive layer 16 are large and may be very flexible and cumbersome to move, it may be advantageous to use pneumatic vacuum handling equipment (including suction cups) to engage the decorative sheets 12 and position the sheets relative to each other to form the stack 10. For example and referring to FIG. 2, the stack 10 may be formed by placing decorative sheet 12c onto sheet 12d, then placing sheet 12b onto sheet 12c, then placing sheet 12a onto sheet 12b to form the stack 10, with the dry, pressure sensitive adhesive layer 16 of each sheet adhering to the top surface 14a of the adjoining, lower sheet. As implied by this description, any release layer 18 was removed from all but the bottom sheets before stacking those sheets. The bottom sheet 12 (e.g., sheet 12d in FIG. 2) may also be positioned with such vacuum handling equipment because it has both the top surface 14a of the bottom sheet and the release layer 18 available for contact and manipulation by vacuum handling equipment. Further, if one or more of the decorative sheets 12 are provided with a release layer 18 then either side of the decorative sheet may be engaged with the vacuum handling equipment for layering to form the stack 10, with the release layer 18 being removed before placing the sheet onto other sheets to form the stack 10. Each stack 10 advantageously has only one release layer 18 and that is on the bottom sheet (e.g., sheet 12d in FIG. 2), but has more than one decorative sheet 12 in the stack.

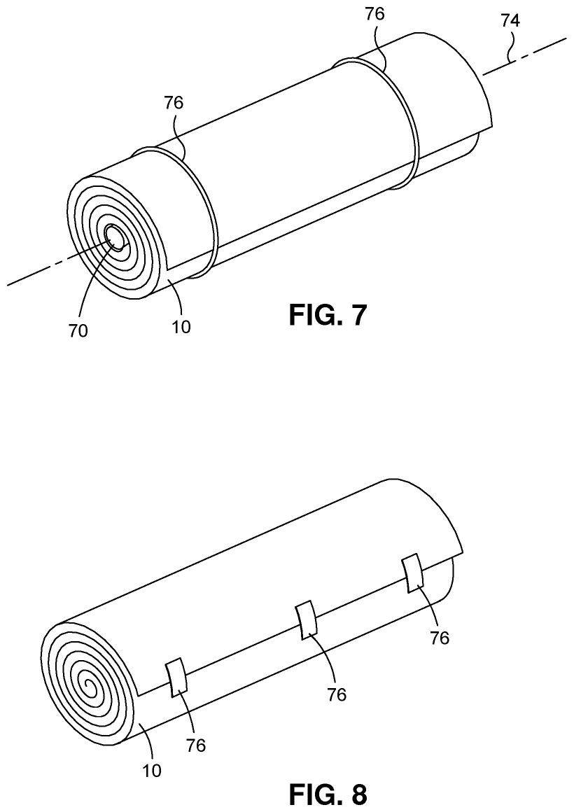

Referring to FIGS. 7 and 8, for shipping, a plurality of stacks 10 are laid on top of each other, with the release layer 18 on the bottom of each stack preventing the stacks from adhering to each other, to form a larger stack 68 of stacks 10. The larger stack 68 of stacks 10 may be temporarily clamped together by spring clamps or binder clips of the type used to hold small stacks of sheets of paper together—but preferably having a longer length. The larger stack 68 of stacks 10 may be releasably connected to a backing support of a thin but stiff piece of cardboard, fiberboard, wood or plastic having the same width and length as the larger stack 68, to provide a less flexible unit for shipping and handling. The larger stack 68 may be wrapped in transparent wrap or cellophane to bind the individual stacks 10 together to form a more sturdy unit for handling and shipping. The larger stack 68 may be placed inside a cardboard box of suitable size for shipping and handling or releasably fastened to a backing board or support surface such as a sheet of plywood, fiberboard, plastic or other stiff material.

As noted elsewhere, the decorative sheets 12 are large (e.g., 4×8 feet) but very thin (e.g. 0.06 inches), so the drawings are not to scale if they are to show individual sheets 12 within a stack 10, or to show individual stacks within a larger stack 68 of stacks 10.

Rolled Stacks

Referring to FIGS. 7-9B, because the decorative sheets 12 are large and thin, further advantages are available. A stack 10 of large decorative sheets 12 may be 4×8 feet in size (or larger), but only about 0.06 inches thick. Shipping individual stacks 10 of large sheets 12 is difficult because the stacks are large, unwieldy to handle, heavy, and because of their large size compared to total thicknesses they may flex, bend and twist if they are not uniformly supported along the length and width of the stack and that complicates shipment and handling. These problems may be greatly lessened by rolling one or more stacks 10 into a cylinder that may be hollow (FIG. 7), or rolling one or more stacks 10 around a central support 70 to form a roll 72 (FIG. 8) that are much easier to handle and ship, while providing users with great flexibility in producing large or small stacks from the roll of stacks. Restraining bands 76, such as elastic bands, metal bands, or adhesive tape may be used to hold the stacks 10 in the rolled-up configuration, with or without the central support 70. The central support 70 is typically a cylindrical shaft of metal or cardboard, and preferably a tube to reduce weight.

Advantageously, a very long stack 10 of decorative sheets 12 (referred to herein as an elongated strip 10′ may be rolled into a cylinder (FIG. 8), preferably rolled about the central support 70 to form the roll 72 (FIG. 7), with the roll shipped to manufacturers who make smaller stacks from the roll. The process for creating a roll of elongated strips 10′ of decorative material is similar to that of creating the sheets except the adhesive backed sheets are not cut transversely to the edge of the sheet and are instead rolled continuously onto a take-up roll such as central support 70 to form the roll.

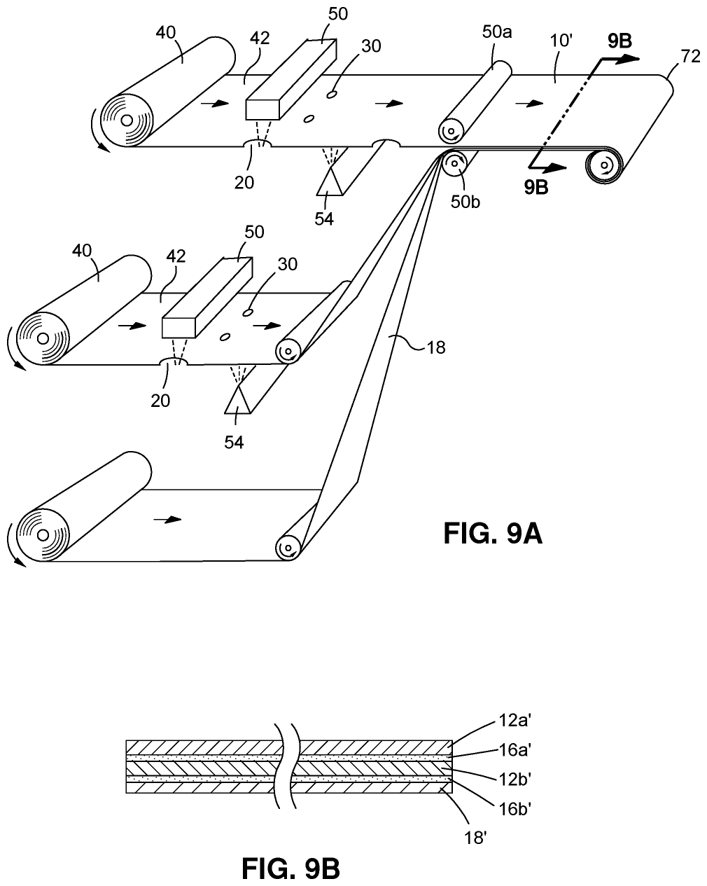

Referring to FIGS. 9A-9B, for example, first and second rolls of decorative material 40 provide top and bottom elongated strips 12a′ and 12b′, respectively. Each elongated strip passes through a cutting station 56 where any initial release areas 20 and any holes 30 are formed and further pass through an adhesive applicator 54 where adhesive layers 16a′, 16b′ are applied to the elongated strips 12a′ and 12b′, respectively. The resulting adhesive coated strips 12a′ and 12b′ are laminated together along with release layer 18 being laminated onto the bottom side of the adhesive layer 16b′ to form a decorative strip 10′ (FIG. 9B) that is rolled around central support 70 to create roll 72. Additional decorative strips 12 and adhesive layers 16 can be provided.

The roll 72 may have a single elongated strip 10′ that is four to eight (or more) feet wide but tens of feet long, or longer, with lengths of 100 to 150 feet and even longer believed suitable for use. To prevent unrolling or unspooling of the rolled elongated strip 10′ the periphery of the roll 72 is restrained by a restraining band 76 (FIGS. 7-8). The restraining band may encircle the circular periphery of the roll 72 (FIG. 7), or it may be a series of tape strips or other releasable fasteners holding the loose, distal end of the wound elongated strip 10′ to the remainder of the roll 72 (FIG. 8).

The maximum size of the roll 72 is typically limited by either weight or diameter of the roll 72, and the number and thickness of the separate decorative strips 12′ and release layer 18 in each stack 10 which affects the thickness of each elongated strip 10′ and the diameter and weight of the roll 72. But advantageously, the size of the roll 72 is determined by the size of the elongated strip 10′, which may be determined by the number of shorter stacks 10 a particular customer wants to make from the elongated strip, or by the number of shorter stacks a customer is capable of making from the elongated strip.

The roll 72 may be shipped to manufacturers who remove the restraining bands 76 and unwind the elongated strip 10′ from the roll 72 as needed to form shorter stacks 10 from that elongated strip. Typically, the central support 70 can be mounted to rotate about the longitudinal axis 74 of the central support to dispense the length of the elongated strip 10′ required for manufacturing as the need arises. The manufacturer may cut the unrolled portion of the elongated strip 10′ into smaller stacks suitable for the particular use or uses of the manufacturer or customers of the manufacturer as shown and discussed regarding the sizing station 58 of FIG. 6. Advantageously, the cuts may take advantage of the initial release areas 20 and any holes 30 in the rolled-up, elongated stack, when forming the smaller stacks. For example, a transverse cut perpendicular to the length of the roll 72 may pass through the center of an initial release area 20 and thus provide a release area at the top of one stack 10 and at the bottom of the adjoining stack formed by the cut.

Moreover, the roll 72 may contain an elongated strip 10′ having periodically located initial release areas 20 and/or holes 30 formed in the elongated stack with the length measured in tens of feet, or even hundreds of feet in length. Such elongated stacks 10 may be used by manufacturers who cut the stacks to a desired shape and a desired width and length, taking advantage of the pre-formed initial release areas 20 and/or holes 30 in cutting the smaller stacks from the roll 72 formed from the elongated stack.

Further, while the roll 72 has the same number of decorative strips 12′ throughout the length of a particular elongated strip 10′ wound on the roll 72, a manufacturer can remove the release liner 18′ from a portion of the strip before or after the sizing station cutting operations, and then use the bottom adhesive layer 16 to releasably adhere that portion to another stack 10 to create stacks having additional decorative sheets 12 and different stack thicknesses. Thus, for example, an elongated strip 10′ having a length of 100 feet can be wound around the roll 72 and have four sheets 12a through 12d. By removing the release layer 18 from a 10 foot length of the roll 72 to expose adhesive layer 14d (FIG. 2) and adhering that layer 14d to the top of a prior ten foot length removed from the same roll 72, the manufacturer could form a stack that is ten foot long with 8 decorative layers. Stacks with 12, 16, 20 etc. layers could similarly be created, depending on the number of times the adhesive layer 18 was removed so additional lengths of the elongated stack could be cut off and layered on top of each other, with the thickness increasing by multiples of the number of sheets 12 in the elongated strip 12′ rolled up in roll 72.

As each elongated strip 10′ is wound around the central support 70 each elongated strip 10′ curves about the longitudinal axis 74 of the central support 70 and those strips 12′ that are radially closer to that axis curve more than those sheets that are further from that axis. But the adhesive layers 16 between each decorative strip 12′ restrain the adjoining strips from easily sliding over each other to conform to the curvature imposed by winding the elongated strip 10′ around the central support 70. It is thus advantageous to have the elongated strip 10′ be thin so as to minimize the shear that arises in the adhesive layers 16 between the decorative strips 12′ in the elongated strip 10′. The portion of the elongated strip 10′ closest to the central support 70 curves the most and has the most shear stress in the adhesive layers, while the portions of the elongated strip 10′ on the outer periphery of the roll 72 have a greater curvature and less shear within the adhesive layers.

Elongated strips 10′ of large sheets 12 having a stack thickness of under 0.2 inches, and preferably under 0.1 inches are believed suitable for winding around the central support 70. Advantageously, the elongated strip 10′ is wound with the longest dimension extending along the spiral direction in which the elongated stack is wound around the central support 70, with the shortest dimension of the width or length extending along or parallel to the longitudinal axis.

As noted, the sheets 12 have predetermined initial release areas 20 and may have holes 30 for support pins or posts. The manufacturer may order the elongated strip 10′ to have these initial release areas 20 and/or holes 30 in predetermined locations to suit the manufacturer's needs or the needs of the manufacturer's customers. For example, the manufacturer may order an elongated strip 10′ precut to make sheets 12 where the sheets are 40 foot long with holes 30 every 8 feet and initial release areas 20 at 8 foot intervals along only one edge, so the elongated strip 10′ can be cut into eight foot lengths and after removing the release layer 18 the resulting stack 10 may be adhered to walls of a bathroom with support pins or posts 26 extending from the bathroom walls and through the holes 30 to support and position the stack on the wall. The initial release areas 20 may be located at a corner of the stack, with the stack positioned in a location in the bathroom that the initial release area is difficult to see and/or reach. When the exterior decorative sheet is damaged or covered with graffiti, it may be removed to expose the next decorative sheet by using a screwdriver or fingernail to pry loose the top sheet at the initial release area 20 and then then peeling the top sheet off. The same applies to successive sheets 12, after which the stack 10 may be replaced.

The manufacturer may also order the elongated strip 10′ to have initial release areas 20 and/or holes 30 that may or may not be needed, depending on the ultimate use of the manufacturer or the manufacturer's customer. In such situations, the stack 10 is cut from the elongated strip 10′ to the desired size and shape and the stack may have one or more initial release areas 20 and/or holes 30 that are not used and may have the initial release areas able to be placed in a location that is difficult to access or to see.

The manufacturer may also order an elongated strip 10′ to have no initial release areas 20 and/or holes 30, in which case the manufacturer may provide its own sizing station 58 to cut the elongated strip 10′ into stacks 10 of the desired sizes and configurations, or the manufacturer provides its own cutting station 56 cuts its own holes 30 and initial release areas 20 where needed. Forming an initial release area 20 in the individual sheets 20 is believed desirable compared to cutting release areas in a stack 10. But even an accessible corner may allow a user, with sufficient instructions and knowledge of the construction of the stacks 10, to separate the top decorative sheet 12 and peel it off the stack to expose the next sheet in the stack.

The elongated strip 10′ that is wound to form the roll 72 may have a plurality of initial release areas 20 at periodic locations along any peripheral edge of the stack, and at various locations within the perimeter of the stack that preferably coincide with predetermined sizes of smaller-dimensioned stacks if that stack is to be later cut into smaller stacks. The initial release areas 20 may be of the same size or of periodically varying size to form stepped or staggered edges when cut and assembled into differently sized stacks. The same logic applies to the sequence used to produce stacks of individual sheets as described in FIGS. 5-6.

Thus, for example, the initial release areas 20 shown in FIG. 6 may be sequentially and periodically increased (or decreased) in size so that when the elongated strip 10′ is cut through the centers of periodically located release areas 20 and the resulting cut sheets 12 are stacked on top of each other so the centers of the release areas align along an axis, then a stairstep-shaped release area is created. Likewise, a plurality of holes 30 for support pins may optionally be formed at predetermined locations in the elongated strip 10′, although the holes 30 are typically located entirely within the periphery of the sack 10 but could be formed partially in the periphery to form notches for positioning and support of the resulting stack 10.

Thus, for example, the initial release areas 20 may be formed in slightly different sizes (shapes or configurations) in sequential decorative sheets 12 so when they are stacked on top of the immediately preceding sheet the result is to form the various release areas shown in FIGS. 3A-3G, or other arrangements, when the decorative sheets 12 are arranged on top of each other to form the stack 10. For example, to form an initial release area 20 having a reverse stair-step profile with a larger opening on the top sheet 12a and a smaller (or no) opening on the bottom sheet 12d, each successive decorative sheet 12 would have an initial release area 20 of slightly different size.

For a reverse stair step profile (FIG. 3G) each initial release area 20d, 20c, 20b and 20a would be cut with a successively smaller size so that sheets are stacked in the order listed, the smallest initial release area 20a is on the top sheet of the stack 10 (the last sheet stacked), while the largest initial release area 20d is on the bottom sheet of the stack 10 (the first sheet of the stack) and all initial release areas are aligned. For a stair-step shaped initial release area (FIG. 3F) the size of each successive release area would increase slightly instead of decreasing slightly in size. In a similar manner, alternating decorative sheets could have edges that are extended or recessed to form staggered profiles for the initial release areas 20 as in FIGS. 3A-3C. The adhesive layer 14 could also be manipulated to provide flexible areas of the peripheries of the sheets 12 adjacent various locations that may be cut to form a periphery of a smaller sheet 12, or that may form a portion of an initial release area 20.

The posts 26 (which includes pins and bolts) are preferably cylindrical but may have other cross-sections, such as cross sections having from 4 to eight straight sides, including trapezoidal and rectangular cross sections (which include a square), and including curved cross sections such as elliptical and ovals cross sections. The holes 30 preferably conform to the cross-sectional shape of the posts 26, and are located sufficiently inward from the periphery of the decorative sheet 12 that the stack 10 is suspended in whole or in part by the posts 26 engaging the holes 30, although advantageously the bottom edge of the stack rests against a support, such as the floor or the ledge 28. The posts 26 and mating holes 30 are preferably located entirely within the periphery of the stack 10. But the posts can cooperate with partial holes 30 formed in the peripheral edges of the stack 10 to support and/or position the stacks. Locating the holes 30 within the periphery of the stack 10 is preferred because it allows the stack 10 to be suspended from the posts 26 whereas resting a bottom edge of the stack 10 on a post could result in the thin sheets 12 and stack 10 bowing or otherwise deforming and slipping off the posts. Advantageously, at least two posts 26 are used to suspend a stack 10.

The complete contents of each of the patents and published patent applications identified herein, is hereby incorporated by reference.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A roll of decorative laminates, comprising:
a plurality of elongated strips of decorative material having opposing top and bottom sides, the elongated strips having a length greater than ten feet and a width of at least one foot and including at least a top strip and a bottom strip with the bottom side of each of the plurality of elongated strips having a dry, pressure sensitive adhesive configured to releasably adhere to an adjoining top side of a different one of the plurality of elongated strips except for the bottom side of the bottom strip which is releasably adhered to a release layer, each of the elongated strips having a thickness less than 0.02 inches and a refractive index greater than 0.2, the elongated strips having a plurality of initial release areas at periodic locations along the length of the elongated strip; and
wherein the elongated strips of decorative material are wound around a longitudinal axis to form the roll.

2. The roll of claim 1, further comprising an elongated central support extending along the longitudinal axis with the plurality of elongated strips of decorative material wound around the central support to form the roll.

3. The roll of claim 2, wherein there are 3 to 10 elongated strips.

4. The roll of claim 2, wherein each of the plurality of initial release areas has a center measured along the length of the strip and wherein a distance between each of those adjacent centers is the same.

5. The roll of claim 4, wherein a further plurality of the plurality of initial release areas have a periodic variation in size.

6. The roll of claim 1, wherein the plurality of initial release areas are located along at least one edge of a further plurality of the elongated strips.

7. The roll of claim 2, wherein the initial release areas are located within a periphery of the elongated strips.

8. The roll of claim 2, further comprising a plurality of holes extending through the plurality of elongated strips with the holes aligned parallel to an axis perpendicular to the top surface of the top sheet when the sheet is flat, the holes having a circular or quadrilateral shape.

9. The roll of claim 2, wherein each of the elongated strips comprises PET.

10. The roll of claim 2, wherein each of the elongated strips comprises PET and wherein the dry, pressure sensitive adhesive comprises PMMA.

11. The roll of claim 2, wherein the elongated strips are opaque.

12. The roll of claim 2, wherein each elongated strip has printed indicia thereon, which printed indicia is the same on each elongated strip

13. The roll of claim 2, wherein each elongated strip includes printed indicia that repeats itself a plurality of times along the length of the elongated strip, and wherein the printed indicia comprises an image is selected from the group consisting of: stone, wood, water or metal.

14. The roll of claim 2, wherein there are 3 to 10 elongated strips, wherein the plurality of initial release areas are located along at least one edge of a further plurality of the elongated strips, and further including a plurality of holes extending through the plurality of elongated strips with the holes aligned parallel to an axis perpendicular to the top surface of the top sheet when the sheet is flat, the holes having a circular or quadrilateral shape.

15. The roll of claim 2, wherein each of the plurality of initial release areas has a center measured along the length of the strip and wherein a distance between each adjacent center is the same but a still further plurality of the plurality of initial release areas have a periodic variation in size.

16. The roll of claim 2, wherein the elongated strips are at least 50 feet in length.

17. A method of manufacturing a stack of decorative sheets, comprising:
unrolling at least a portion of the roll of claim 2;
cutting through the elongated strips and release layer at a location passing through at least one initial release area to form the stack with each elongated strip forming a sheet of the stack.

18. The method of claim 17, wherein the cutting step does not pass through at least one initial release area in the stack.

19. The method of claim 17, wherein the cutting step includes cutting through at least one initial release area located entirely within the periphery of the elongated strip.

20. The method of claim 17, wherein the cutting step does not pass through at least two holes located entirely within the periphery of the stack.

21. The method of claim 17, wherein the cutting step comprises cutting along the length of the elongated strip and also cutting transverse to the length of the roll.

22. The method of claim 17, wherein the initial release area comprises a stairstep configuration and wherein each elongated strip comprises a step in that stairstep configuration.

23. The method of claim 17, wherein the elongated strips contain printed indicia that is repeated a plurality of times, and the cutting step is selected to form the stack so it has that printed indicia on each sheet in the stack.
